(19) United States
(12) Patent Application Publication
(10) Pub. No.: US 2008/0251607 A1
(43) Pub. Date: Oct. 16, 2008

(54) SPRAY GUN

(75) Inventors: Elmar Krayer, Langenargen (DE); Jens Ulbrich, Friedrichshafen (DE); Christoph Welte, Uberlingen (DE)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(73) Assignee: J. WAGNER GMBH, Markdorf (DE)

(21) Appl. No.: 12/059,477

(22) Filed: Mar. 31, 2008

(30) Foreign Application Priority Data
Apr. 12, 2007 (DE) 20 2007 005 381.9

(51) Int. Cl. B05B 7/12

(52) U.S. Cl. 239/290

(57) ABSTRACT

A spraying system for spraying fluids such as paints using high volume low pressure air, the system having a spray gun with a gun housing, a handle, a fluid tank on the gun for holding the fluid to be sprayed, and an atomizer nozzle; the system also including a compressed air generator separate from the gun and including a blower, and an air hose connected between the generator and gun for supplying compressed air to the spray gun, at least one operating element on the gun for switching the compressed air generator on/off and controlling the power of the generator. The switching and control information from the operating element is supplied by a transmission element, such as a wire cable or radio frequency link, to control elements associated with the compressed air generator to switch the generator on and off and to control the power of the generator.

### FIELD OF THE INVENTION

The present invention relates to a spray gun for spraying fluids, in particular paints, by means of a large air volume under low air pressure, principally comprising a gun housing, a handle for holding the spray gun, a fluid tank arranged on the gun housing for holding the fluid to be sprayed, an atomizer nozzle, a compressed air generator arranged outside the gun housing, in particular a blower, as well as an air hose for supplying compressed air from the compressed air generator to the spray gun.

### BACKGROUND OF THE INVENTION

Compressed air spray guns for spraying fluids are used in a wide variety of applications. As well as the main application, i.e. spraying paints, it is also possible to spray products such as herbicides.

When using HVLP spray guns (high volume low pressure spray guns), fluids are sprayed by means of a large air volume and a low air pressure. In this case, the spray gun is connected to a blower by means of an air hose and the blower supplies it with compressed air for spraying the fluid. The spray gun and the blower are therefore separate units that are only connected together by the air hose. The on/off switch as well as any operating switch for adjusting the power of the blower are installed on the blower, which means the user of the spray gun has to operate the controls on the blower at a distance from the spray gun in order to switch it on or off or to adjust the power. This is troublesome for a user, in particular during a spraying procedure; in general it requires the user to set down the spray gun and walk to the blower in order to make the necessary settings on the blower. It is therefore the task of the present invention to design the aforementioned spray gun in such a way that the blower can be switched on/off or its power adjusted without the need to go to the trouble of operating switches on the blower and with a straightforward means of handling, with the result that switching operations can be performed directly on the spray gun so that the spray pattern of the spray gun can be adjusted in short order and in an optimum way.

### SUMMARY OF THE INVENTION

This task is solved in a spray gun of the aforementioned kind in that at least one operating element for switching the compressed air generator on/off and/or controlling and/or regulating the power of the compressed air generator is arranged on the gun housing and/or on the handpiece and that the switching or control information taken from the operating element can be supplied to control elements assigned to the compressed air generator by means of a transmission element, by means of which the compressed air generator can be switched on and off and/or its power can be controlled and/or regulated.

In a various embodiments, a radio transmitter and a radio receiver, or a pair of radio transceivers, or an electrical cable, or a fiber optic cable system, or an infrared operating system, or a pneumatic system, or a hydraulic system, or a Bowden cable system may be provided as the transmission element.

In a further embodiment, the electrical cable is integrated in the air hose and serves as a supporting structure for the air hose. This means transmitting the switching and control information by an electric cable in the air hose does not require a separate electrical cable to be added to the air hose, because the cable that serves to support the air hose or the wire in the air hose is used for this purpose.

In particular, the electrical cable has a spiral shape. With the electrical cable having a spiral geometry, it is possible for the mechanical support of the air hose to be provided particularly effectively.

In a supplementary embodiment, the trigger used for operating the spray gun is provided as the operating element, in particular for switching the electric motor and/or the blower on and off.

In another embodiment, the operating element takes the form of a power adjustment unit for controlling and/or regulating the power of the compressed air generator and an on/off switch for switching the compressed air generator on and off. Controlling the power and switching the compressed air generator on and off can therefore be performed using two separate operating elements, namely a power adjusting unit and an on/off switch.

In particular, the power adjusting unit and/or the on/off switch are arranged on two sides of the gun housing which may be opposite one another. The power adjusting unit and the on/off switch can therefore be operated conveniently on the gun housing by either a left-handed or right-handed person.

In a further embodiment, a coupling element is attached to one or both ends of the air hose for connecting it to the spray gun and/or the compressed air generator. This means the air hose can be quickly, easily and reliably connected to the spray gun and/or the compressed air generator.

For this purpose, a matching coupling element is formed on the spray gun and/or the compressed air generator for connecting to the coupling element attached to the air hose. This means the coupling element only has to be plugged into its matching coupling element in order to connect the air hose to the spray gun and/or compressed air generator.

In a supplementary embodiment, at least one electrical contact is provided on the coupling elements and at least one electrical matching contact is provided on the matching coupling elements in order to establish an electrical connection between the compressed air generator and the spray gun.

In a preferred embodiment, switching or control information can be transmitted from the compressed air generator to the spray gun or vice versa by means of the transmission element. This means, for example, operating data of the compressed air generator can be shown on the display on the gun housing.

The drawing shows certain sample embodiments configured in accordance with the present invention, the details of which are explained below.

### BRIEF DESCRIPTION OF THE DRAWINGS

FIG. 1 shows a spraying system including a compressed air spray gun connected by an air hose to a compressed air generator, all in a schematic view.

FIG. 2 shows an embodiment of the compressed air spray gun in accordance with FIG. 1 in a side view.

FIG. 3 shows an ON/OFF switch for the spray gun in accordance with FIG. 1 in an ON position, in a cross section taken along line III-III in FIG. 2.

FIG. 4 shows is a view of the switch of FIG. 3 except in an OFF position.

FIG. 5 shows a coupling element attached to an end of the air hose, in a perspective view.

FIG. 6 shows a matching coupling element on the compressed air generator, in a perspective view.

FIG. 7 shows a portion of the air hose with two electrical cables, in a perspective view.

### DETAILED DESCRIPTION

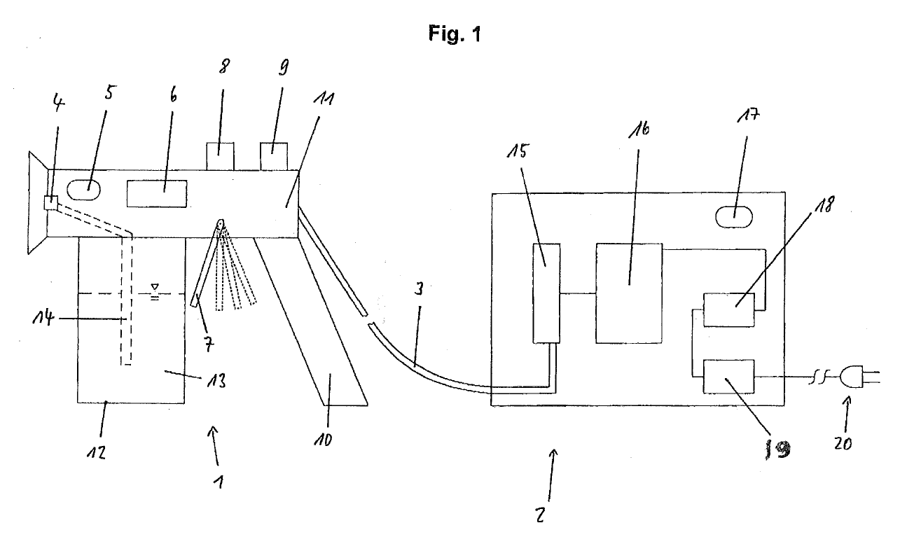

A spray gun 1 for spraying paint by means of a large air volume under low air pressure, i.e. of the HVLP type (high volume low pressure), is shown in FIG. 1, with compressed air supplied to it by means of an air hose 3 from a blower 15 in a compressed air generator 2. The spray gun 1, the air hose 3 and the compressed air generator 2 can also be referred to as a spraying facility or spraying system. The fluid 13 to be sprayed is stored in a fluid tank 12 on the spray gun 1 with a gun housing 11. The pressurization of the fluid tank 12 with compressed air causes the fluid 13 to be sprayed to flow through a supply line 14 to a valve 4 for fluid 13 where it is then sprayed.

A power adjusting unit 8, an ON/OFF switch 9 and a display 6 may be attached to the gun housing 11. Furthermore, there may be a radio transmitter or transceiver 5 in the gun housing 11 for transmitting switching and control information. The display 6 shows operating information of the spray gun 1 and the compressed air generator 2, e.g. operating pressure, fault messages, temperature of the fluid 13, and power or ON/OFF switching status of the compressed air generator 2. A handpiece or handle 10 is used for holding the spray gun 1. A trigger 7 that swivels on the gun housing 11 is attached between the fluid tank 12 and the handpiece 10. In one embodiment, the trigger 7 can be moved to four different switching positions. The first switching position is shown by a solid line while the other three switching positions are shown by broken lines.

The compressed air generator 2 is provided with the blower 15, an electric motor 16 for driving the blower, a power adjusting element 18, an ON/OFF element 19, a radio receiver or transceiver 17 and a plug 20 for connecting the compressed air generator 2 to an electrical system. The electric motor 16 can be switched ON and OFF by means of the ON/OFF element 19. The power of the electric motor 16 and therefore also the power of the blower 15 can be controlled by means of a power adjusting element 18.

The four different switching positions of the trigger 7 allow different control settings of the electric motor 16 and the valve 4 to be made. In the first switching position (solid line), the electric motor 16 is switched OFF and the valve 4 closed. As the trigger 7 is moved further to a second switching position (broken line), the electric motor 16 is switched ON but the valve 4 remains closed. In the third switching position (broken line), the valve 4 is opened at a minimum position with the electric motor 16 switched ON fully. Moving the trigger 7 to the last, fourth switching position (broken line) opens the valve 4 to maximum extent with the electric motor 16 continuing to be fully switched ON. In addition, the power adjusting unit 8 enables the power of the electric motor 16 to be controlled and/or regulated and the electric motor 16 can be switched ON and OFF with the ON/OFF switch 9. The spray gun 1 can also be configured without an additional power adjusting unit 8 and/or ON/OFF switch 9 (not illustrated), i.e. the electric motor may be controlled exclusively using the trigger 7.

In one variant, the power of the electric motor 16 can be infinitely varied between the third and fourth switching positions of the trigger, between the lowest power in the third position and the highest power in the fourth position.

In one embodiment, the control signals triggered by the corresponding devices (not shown) on the trigger 7 may be provided to the radio transmitter or transceiver 5 in the gun housing 11. The radio transmitter or transceiver 5 transmits the control signals to the radio receiver or transceiver 17 in the compressed air generator 2 which passes on the control signals to the power adjusting element 18 and the ON/OFF element 19. The power adjusting element 18 and the ON/OFF element 19 therefore enable the electric motor 16 in the compressed air generator 2 to be switched ON and OFF as well as its power to be controlled based on the various switching positions of the trigger 7 on the spray gun 1.

The coupling between switching the electric motor ON and OFF and the operation of the valve 4 means that the electric motor 16 or the blower 15 only operates when fluid 13 is being sprayed. This means the noise load and electricity consumption can be reduced. When elements 5 and 17 are radio transceivers, operating data from the compressed air generator 2 may be transmitted to the display 6 on the spray gun 1, it being understood that when elements 5 and 17 are transceivers, each of elements 5 and 17 can serve as a radio transmitter and radio receiver.

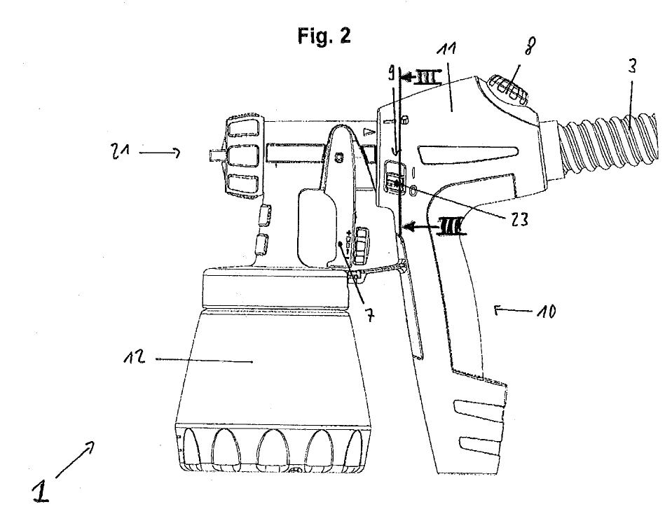

In the spray gun 1 in accordance with FIG. 2, the trigger 7 only sets the position of the valve 4 for the fluid 13 on the atomizer nozzle 21. A separate ON/OFF switch 9 arranged on the gun housing 11 is used for switching the electric motor 16 in the compressed air generator 2 ON and OFF. The ON/OFF switch 9 is preferably accessible on both sides of the gun housing 11, which means the switch 9 can be operated conveniently by left handed and right handed people. In one embodiment, the power of the electric motor 16 can be infinitely variably controlled with the power adjusting unit 8.

In one embodiment the control signals are transmitted from the spray gun 1 to the compressed air generator 2 with the power adjusting element 18 and the ON/OFF element 19 by means of two electrical wires or cables 22 in the air hose 3 (FIG. 7). The two electrical cables 22 in the air hose 3 are preferably configured as wire spirals that are integrated in the air hose 3 as a mechanical supporting structure as shown in FIG. 7.

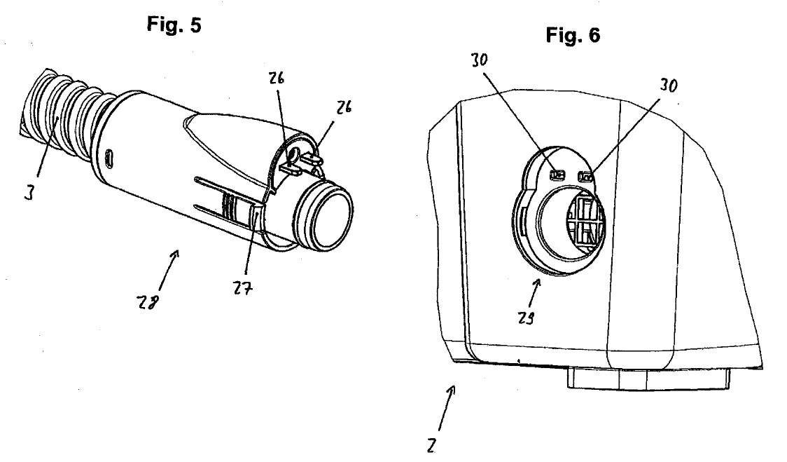

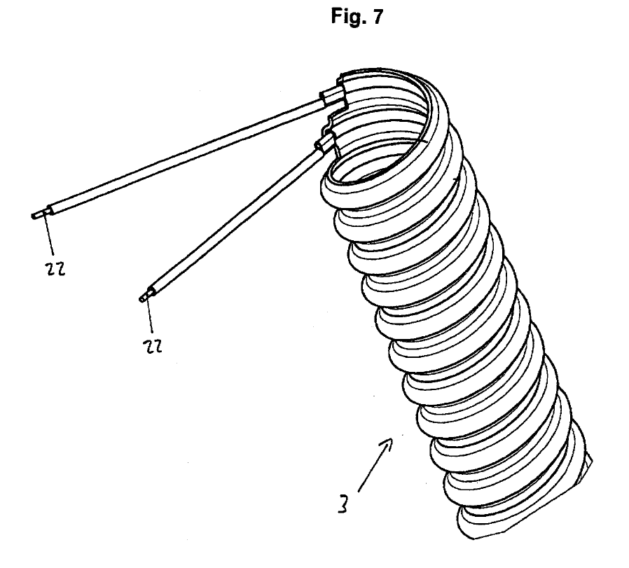

Each of the ends of the flexible air hose 3 is provided with a coupling element 28 (FIG. 5). In this embodiment, two electrical contacts 26 and two detent projections 27 are formed on the coupling element 28. The coupling elements 28 on the air hose 3 are inserted into appropriately complementary shaped matching coupling elements 29 on the spray gun 1 and on the compressed air generator 2. The detent projections 27 are used for mechanically securing the coupling element 28 to the matching coupling element 29. By means of electrical contacts 26, the electrical control signals are transmitted to electrical matching contacts 30 in the matching coupling elements 29 when connected. When connected to the matching coupling element 29, the coupling element 28 is preferably air-tight for compressed air so that compressed air can be transferred from the blower 15 through the air hose 3 to the spray gun 1. This means there is an electrical and a pneumatic connection between the compressed air generator 2 and the spray gun 1 in this embodiment.

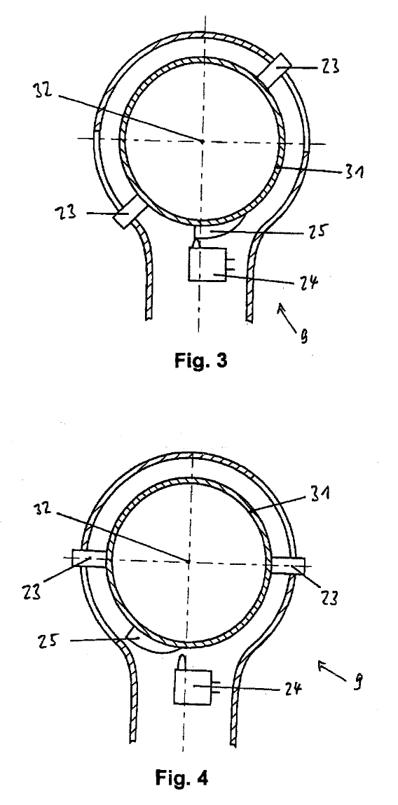

The ON/OFF switch 9 on the gun housing 11 has a switching nipple 23 provided on two sides (FIGS. 3, 4). The two switching nipples 23 are attached to a switching ring 31 that is rotatably mounted about one point of rotation 32. A switching wedge 25 on the ring 31 operates an electric switch 24. In the rotational position of the switching ring 31 shown in FIG. 3, the blower is switched ON and in FIG. 4 it is switched OFF.

In each of the embodiments described, the spray gun 1 allows convenient, rapid and reliable remote operation and remote control of the compressed air generator 2 from the spray gun 1. The user therefore does not need to set down the spray gun 1 during use in order to make adjustments to the blower 15. This allows the user to adjust the power of the spray gun 1 during the spraying operation, i.e. to correct the spray pattern of the spray gun when spraying and this makes it possible to achieve an optimum setting of the spray pattern in a straightforward manner and simultaneously with the spraying operation. In addition, the blower 15 can be conveniently switched OFF during even brief breaks in spraying, thereby reducing the noise load and the energy consumption. Furthermore, the blower 15 can be switched OFF more rapidly by the user in case of a malfunction than if the ON/OFF switch were mounted on the compressed air generator, because there is no need to walk to the compressed air generator 2, i.e. efficiency is increased because of the shorter switch-off time in the event of a malfunction.

The need for the user to walk to the compressed air generator 2 also represents a risk of tripping, and this risk is therefore reduced. The air hose 3 can be made longer than in the prior art because in the present invention the distance between the spray gun 1 and the compressed air generator 2 generally is either unimportant or of hardly any importance. This means the compressed air generator 2 can be protected against the spray mist from the spray gun 1. The compressed air generator 2 can also be set up outside the room where spray painting is in progress, with the effect that a complicated explosion-proof configuration of the compressed air generator 2 is then no longer absolutely essential.

The invention is not to be taken as limited to all of the details thereof as modifications and variations thereof may be made without departing from the spirit or scope of the invention.

What is claimed is:

1. A spraying system for spraying fluids, in particular paints, by means of a large air volume under low air pressure, the system including a spray gun having a housing, a handle for holding the spray gun, a fluid tank arranged on the gun housing for holding the fluid to be sprayed, and an atomizer nozzle; a compressed air generator arranged outside the gun housing, including a blower; and an air hose for supplying compressed air from the compressed air generator to the spray gun, characterized in that at least one operating element for switching the compressed air generator ON and OFF is arranged on the gun and uses a transmission element to provide switching information to at least one control element including a switch located at the compressed air generator to switch the compressed air generator ON and OFF.

2. The spraying system of claim 1 characterized in that the at least one operating element on the gun provides control information to the at least one control element in the compressed air generator to control the power of the compressed air generator.

3. The spraying system of claim 1 characterized in that the transmission element is a radio transmitter and a radio receiver, a pair of radio transceivers, an electrical cable, a fiber optic cable, an infrared operating device, a pneumatic system, a hydraulic system or a Bowden cable system.

4. The spraying system of claim 2, characterized in that when the selected transmission element is the electrical cable, the electrical cable is integrated in the air hose and serves as a supporting structure for the air hose.

5. The spraying system of claim 4, characterized in that the electrical cable (22) has a spiral shape.

6. The spraying system of claim 1 characterized in that the operating element is a trigger located on the spray gun for actuating the spray gun.

7. The spraying system of claim 2 characterized in that the operating element includes a power adjustment unit for controlling the power of the compressed air generator.

8. The spraying system of claim 7 characterized in that the power adjusting unit and the switch are arranged on two sides of the gun housing.

9. The spraying system of claim 1 characterized in that a coupling element is attached to one or both ends of the air hose for connecting it to at least one of the spray gun and the compressed air generator.

10. The spraying system of claim 9 characterized in that a matching coupling element is formed on at least one of the spray gun and the compressed air generator for connecting to the coupling element attached to the air hose.

11. The spraying system of claim 9 characterized in that at least one electrical contact is provided on the coupling element and at least one electrical matching contact is provided on the matching coupling element in order to establish an electrical connection between the compressed air generator and the spray gun.

12. The spraying system of claim 11 characterized in that the at least one electrical contact is a pair of electrical contacts and the at least one electrical matching contact is a pair of electrical matching contacts.

13. The spraying system of claim 1 characterized in that the transmission element transmits information from the compressed air generator to the spray gun for presentation by the display.
